(19) United States
(12) Patent Application Publication
(10) Pub. No.: US 2004/0214611 A1
(43) Pub. Date: Oct. 28, 2004

(54) Mobile terminal and method for displaying a web site using previous display information

(75) Inventors: Ho-Won Jong, Suwon-shi (KR); Chin-Kyu Kang, Suwon-shi (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., KYUNGKI-DO (KR)

(21) Appl. No.: 10/614,415

(22) Filed: Jul. 7, 2003

(30) Foreign Application Priority Data
Apr. 23, 2003 (KR) 25785/2003

(51) Int. Cl. H04M 1/00

(52) U.S. Cl. 455/566; 455/412.1

(57) ABSTRACT

A mobile terminal and method for displaying a web site using previous display information. In the mobile terminal, a memory stores previous display information of a web page previously visited by a user. A controller performs a control operation so that the loaded web page is displayed on a display unit after the controller detects the previous display information of a loaded web page from the memory. In the method, a web page is loaded if the user accessing a wireless Internet requests the mobile terminal to visit the web page. The previous display information of the loaded web page is detected from an internal memory of the mobile terminal and the loaded web page is displayed utilizing the display information. As a result, the mobile terminal and method enable users to easily use the wireless Internet.

### PRIORITY

This application claims priority to an application entitled “MOBILE TERMINAL AND METHOD FOR DISPLAYING WEB SITE USING PREVIOUS DISPLAY INFORMATION”, filed in the Korean Industrial Property Office on Apr. 23, 2003 and assigned Serial No. 2003-25785, the contents of which are hereby incorporated by reference.

### BACKGROUND OF THE INVENTION

1. Field of the Invention

The present invention relates generally to a mobile terminal capable of accessing the Internet and a method for controlling the same, and more particularly to a mobile terminal and method for displaying a web site using previous display information.

2. Description of the Related Art

With the development of communication techniques, the use of a wireless Internet through a mobile terminal has increased rapidly. However, because a display window of the mobile terminal is conventionally small, the mobile terminal cannot display an entire web page at one time. A user of the mobile terminal must confirm the content of a corresponding web site while scanning a screen of a desired web page using keys of the mobile terminal (e.g., arrow keys or navigation keys). Moreover, since the mobile terminal does not store various display information of the web site previously viewed by the user (hereinafter, referred to as “previous display information” containing cursor or navigation bar position information, display position information, user input information, etc.), the mobile terminal cannot completely redisplay all items of the previous display information when the user again accesses a previously visited web site using the mobile terminal.

In other words, as illustrated in FIG. 1, when a user request is input into the mobile terminal, the mobile terminal loads corresponding web pages at step S11, and simply sequentially outputs the loaded web pages on a display unit at step S13.

Thus, there is a problem in that display information must be reset using a limited user interface of the mobile terminal so that contents desired by the user can be redisplayed, when the user re-visits a web site, which has been previously visited.

Conventionally, users must perform the same procedure to obtain the same information of an arbitrary web site. Thus, there is another problem in that the users desiring to access the information of the web site using the mobile terminal must repeatedly perform the same procedure every time they access a corresponding web site to configure desired display information.

However, because the mobile terminal provides a very limited user interface, when the same procedure is repeatedly performed using the limited user interface, many users feel that this creates too much inconvenience and wastes too much time by performing the same procedure.

### SUMMARY OF THE INVENTION

Therefore, the present invention has been designed in view of the above and other problems, and it is one object of the present invention to provide a mobile terminal and method for enabling users to easily use a wireless Internet.

It is another object of the present invention to provide a mobile terminal and method for displaying a web page utilizing previous display information from a previous visit to the web page.

In accordance with one aspect of the present invention, the above and other objects can be accomplished by the a mobile terminal, comprising: a display unit; a memory for storing previous display information of a web page previously visited by a user; and a controller for detecting the previous display information in the memory and displaying the web page utilizing the previous display information on the display unit.

In accordance with another aspect of the present invention, there is provided a method for displaying a web site on a mobile terminal, comprising the steps of: (a) loading a web page if a user requests the mobile terminal to visit the web page; and (b) detecting previous display information of the loaded web page from an internal memory of the mobile terminal and displaying the loaded web page utilizing the display information.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a flow chart illustrating a procedure for displaying a web page a conventional mobile terminal;

FIG. 2 is a schematic diagram illustrating a structure of a mobile terminal in accordance with an embodiment of the present invention;

FIGS. 3A to 3C are exemplary views illustrating structures of a database for managing display information in a mobile terminal in accordance with an embodiment of the present invention;

FIG. 4 is a flow chart illustrating an exemplary procedure of displaying a web page on a mobile terminal in accordance with the present invention; and

FIGS. 5A and SB are views illustrating an exemplary method for managing display information in accordance with the present invention.

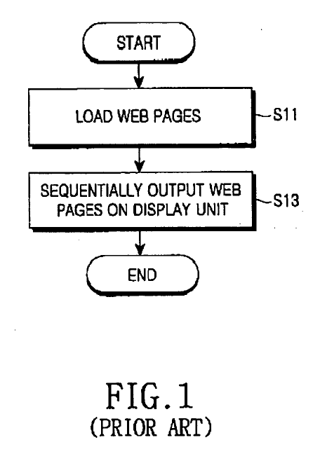

### DETAILED DESCRIPTION OF THE PREFERRED EMBODIMENTS

Preferred embodiments of the present invention will be described in detail herein below with reference to the annexed drawings. In the drawings, the same or similar elements are denoted by the same reference numerals even though they are depicted in different drawings.

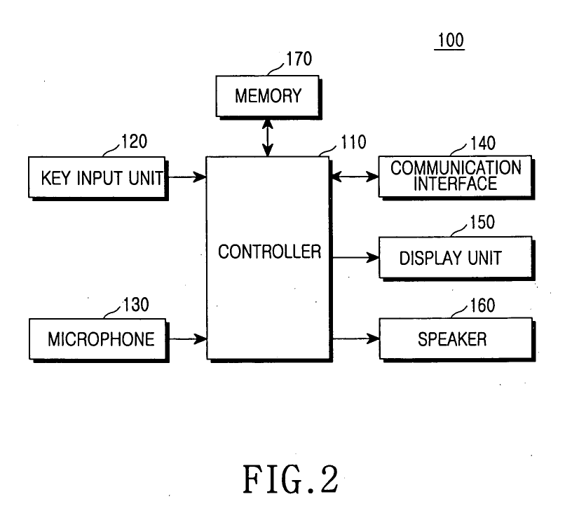

FIG. 2 is a schematic diagram illustrating a structure of a mobile terminal in accordance with one embodiment of the present invention. Referring to FIG. 2, a mobile terminal 100 includes a controller 110, a key input unit 120, a microphone 130, a communication interface 140, a display unit 150, a speaker 160, and a memory 170.

The key input unit 120 receives a key manipulation signal input by a user, and the microphone 130 receives voice of the user. The communication interface 140 transmits and receives various signals. The display unit 150 displays operating states of the mobile terminal 100, and the speaker 160 outputs various audio signals. The memory 170 stores information generated from a program preset to operate the mobile terminal 100 and other information generated while the mobile terminal 100 operates. In particular, the memory 170 stores previous display information (e.g., navigation bar position information, display position information, user input information, etc.) of a web page that has been previously visited (viewed) by the user.

In addition, the controller 110 controls the operation of the mobile terminal 100 in response to a preset operation program, a user command input through the key input unit 120, or a predetermined message received through the communication interface 140.

Specifically, if a web page requested by the user is loaded in the memory 110, the controller 110 detects the previous display information associated with the loaded web page from the memory 170. The controller 110 performs a control operation to enable the display unit 150 to display the loaded web page utilizing the previous display information. For example, a display area to be displayed on the display unit 150 is determined on the basis of previously stored web-page start position information, and the display area determined from the previously stored information is displayed on the display unit 150.

If the previous display information associated with the loaded web page is not stored, the web page is displayed utilizing initial setting information. For example, information of the highest-order display area contained in the loaded web page is determined as start position information of the web page to be displayed, and hence the display area is determined. According to a result of the determination, the display area is displayed on the display unit 150. Examples of a case where the previous display information of the web page is not stored in the memory 170 include the case where the web page will be loaded in the mobile terminal 100 for the first time and the case where the user intentionally does not store the previous display information of the web page.

When a display screen displayed on the display unit 150 is changed by a web page turning operation, an Internet termination operation, etc., the controller 110 collects display information of a currently displayed web page and collects display information to store in the memory 170. At this time, the previous display information can be stored by the user's selection.

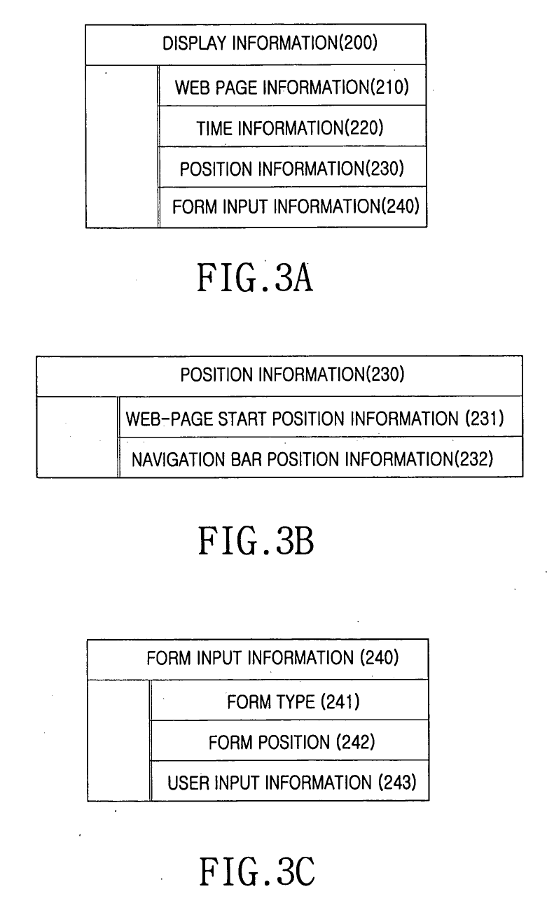

FIGS. 3A to 3C are exemplary views illustrating structures of a database for managing display information in a mobile terminal in accordance with an embodiment of the present invention.

Referring to FIG. 3A, the database for managing the display information 200 in the memory 170 includes a web-page information field 210, a time information field 220, a position information field 230, and a form-input information field 240. The web-page information field 210 stores a uniform resource locator (URL) of the web page or information corresponding to the URL. The URL is used as a key value for identifying the display information. The display information is stored on a page-by-page basis.

The time information field 220 stores a period of time needed for collecting the display information and storing the collected display information in the memory. The time information field 220 is used for determining the validation of the display information later on. For example, when the display information is again applied to the loaded web page, a current time is compared with time information stored in the time information field 220. If the current time exceeds a preset valid time after the period of time stored in the time information field 220, the display information cannot be not used. A value stored in the time information field 220 is periodically checked, and the display information is deleted from the memory 170 when the current time has exceeded the preset valid time.

The position information field 230 stores position information of the display area, to be displayed on the display unit 150 of the mobile terminal 100.

Further, the form-input information field 240 stores form input information contained in a corresponding web page. The display information 200 can include the number of form-input information fields 240 corresponding to the number of user interface forms contained in a corresponding web page. For example, if no user interface form is contained in the corresponding web page, the display information does not contain the form-input information field 240. On the other hand, if two user interface forms are contained in the corresponding web page, the display information 200 can contain two form-input information fields 240.

FIG. 3B illustrates information items stored in the position information field 230 in detail. Referring to FIG. 3B, the position information field 230 includes a web-page start position information field 231 and a navigation bar position information field 232. The web-page start position information field 231 stores start position information of a display area to be displayed on the display unit 150. For example, the web-page start position information field 231 stores coordinates (x, y) corresponding to the upper portion of the left associated with the display area.

The navigation bar position information field 232 stores position coordinates of objects contained in a web page being selected/corrected by the user. At this time, a position of a corresponding object can be stored in the form of coordinates (x, y) as the web-page start position information. Display areas in which objects can be located within the screen are numbered and a number corresponding to an object's position can be stored.

FIG. 3C illustrates information items stored in the form-input information field 240 in more detail. Referring to FIG. 3C, the form-input information field 240 includes a form type field 241, a form position field 242, and a user input information field 243. The form type field 241 stores a type of a user interface form contained in a corresponding web page among types of forms conventionally used in the web page. At this time, as an example, the form type conventionally used in the web page includes an editor box for a key input, a combo box for displaying a plurality of hidden menu items when the user manipulates keys and for displaying a selected menu item at normal times, a check box for displaying the user's selection information in the form of a toggle, etc.

The form position field 242 stores form position information within the entire web page and the user input information field 243 stores input information when user input information corresponding to a user interface form exists.

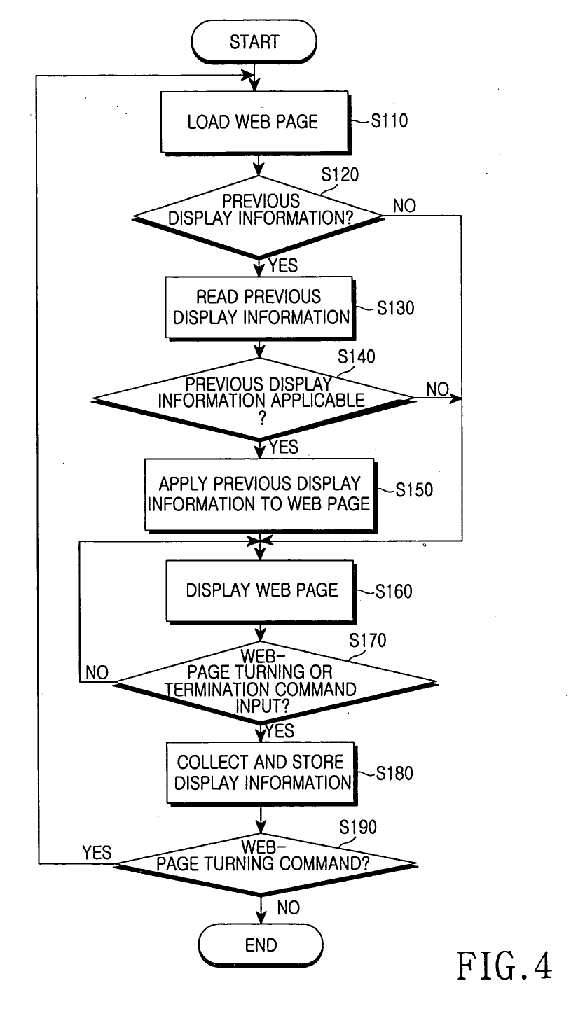

FIG. 4 is a flow chart illustrating an exemplary procedure of displaying a web page on the mobile terminal in accordance with the present invention. Referring to FIG. 4, when a user sends a request to load a web page to the mobile terminal after accessing a wireless Internet using the mobile terminal, the web page is loaded in the mobile terminal in step S110. The mobile terminal (the controller) determines whether previous display information for the web page is stored inside the mobile terminal (e.g., a memory, etc.) in step S120.

If the previous display information for the loaded web page is stored inside the mobile terminal, the mobile terminal reads the previous display information from the memory in step S130 and determines whether the previous display information is applicable in step S140. If so the previous display information is applicable, the web page is displayed after the previous display information is applied to the loaded web page in step S150. However, if the previous display information is not applicable to the currently loaded web page (e.g., a password for user authentication), the mobile terminal does not apply the previous display information to the loaded web page. Regardless of whether the previous display information is applied in S150, the web page is displayed in step S160.

After the user is finished viewing the web page, a web page turning or termination command is input in step S170. Here, the mobile terminal collects display information for the currently displayed web page and stores the collected display information in an internal memory in step S180. At this time, the above step 180 can be omitted on the basis of the user's selection information. For example, if an operating mode of the mobile terminal is set such that the user does not store the display information of the current displayed web page, the procedure can proceed to the next step without storing the display information. However, when the mobile terminal cannot store the current display information because of insufficient memory capacity, a message indicating such an insufficient memory capacity is displayed. Accordingly, the mobile terminal can promote the user to delete the previously stored information and to take action in order that the next step can proceed without storing the current display information.

If it is determined in step S190 that the command input in step S170 was the web-page turning command, the procedure returns to step S110 and repeats the above-described process for the new web page. However, if it is determined in step S190 that the command input in S170 was the termination command (i.e., not the web page turning command), the procedure is terminated.

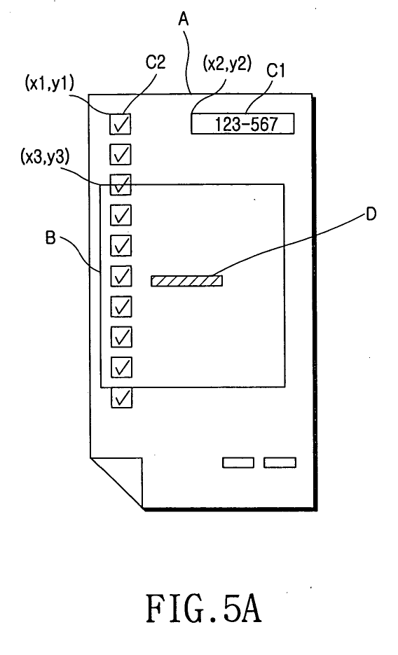

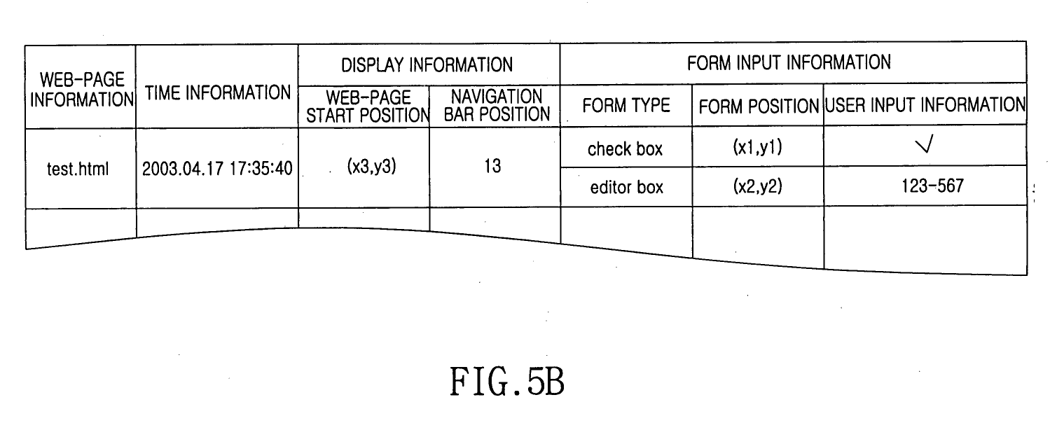

FIGS. 5A and 5B are views illustrating an exemplary method for managing display information in accordance with the present invention.

In FIG. 5A, “A” denotes an entire web page, “B” denotes a display area, to be displayed on the mobile terminal, “C1” and “C2” denote user interface forms contained in the web page, respectively and, “D” denotes a navigation bar. In particular, “C1” denotes an editor box and the “C2” denotes a check box.

In FIG. 5A, a start position of the check box C2 corresponds to coordinates (x1, y1), a start position of the editor box C1 corresponds to coordinates (x2, y2), and a start position of a display area B corresponds to coordinates (x3, y3). These start positions are used as previous display information when a user revisits the web page “A”, thereby enabling the user to view again the web page “A” through display area “B”, and including the information include in boxes C1 and C2, without the user having to manually re-select the display and re-enter any information.

FIG. 5B illustrates an example of previous display information storage. In FIG. 5B, a URL of a web page is “test.html”. The time of collecting the display information is “2003.4.17 17:35:40”. Two forms are contained in the web page as an example. In FIG. 5B, a position of the navigation bar is indicated by “13”. This position indicates that the navigation bar is displayed at an area numbered “13” after areas in which objects can be located are numbered.

In accordance with the present invention, the mobile terminal collects display information of a web page and manages the display information as described above. Accordingly, when the web page is reloaded in the mobile terminal, the mobile terminal can display the web page using previously stored display information.

As is apparent from the description above, the present invention provides a mobile terminal and method, which collect/store display information of a web page at a time of a web-page turning or termination, and display the web page using previously stored display information when re-visiting it, thereby enabling users to easily use a wireless Internet. For example, the present invention enables users to conveniently use desired web page information because the users do not need to repeat the same procedure using a limited user interface.

Although preferred embodiments of the present invention have been disclosed for illustrative purposes, those skilled in the art will appreciate that various modifications, additions and substitutions are possible, without departing from the scope of the invention. Therefore, the present invention is not limited to the above-described embodiments, but the present invention is defined by the following claims, along with their full scope of equivalents.

What is claimed is:

1. A mobile terminal, comprising:
a display unit;
a memory for storing previous display information of a web page previously visited by a user; and
a controller detecting the previous display information of the web page from the memory and displaying the web page utilizing the previous display information when the web page is re-visited.

2. The mobile terminal as set forth in claim 1, wherein the previous display information includes:
a uniform resource locator (URL) of the web page;
display-information collection time information; and
position information of a display area, to be displayed on the display unit.

3. The mobile terminal as set forth in claim 2, wherein the previous display information further includes form-input information contained in the web page.

4. The mobile terminal as set forth in claim 2, wherein the controller detects the previous display information of the web page from the memory, compares a current time with the display-information collection time of the detected previous display information, and displays the web page utilizing the previous display information only if the current time has not exceeded a preset valid time after the display-information collection time.

5. The mobile terminal as set forth in claim 1, wherein the controller collects display information of a currently displayed web page if a web-page turning command is input, and stores the collected display information in the memory.

6. The mobile terminal as set forth in claim 1, wherein the controller collects display information of a currently displayed web page if an Internet termination command is input, and stores the collected display information in the memory.

7. The mobile terminal as set forth in claim 1, wherein the controller periodically checks display-information collection time information previously stored in the memory and deletes corresponding display information when a current time has exceeded a preset valid time.

8. A method for displaying a web site on a mobile terminal, comprising the steps of:
(a) loading a web page if a user accessing a wireless Internet requests the mobile terminal to visit the web page; and
(b) detecting previous display information of the loaded web page from an internal memory of the mobile terminal and displaying the loaded web page utilizing the previous display information.

9. The method as set forth in claim 8, further comprising the step of:
(c) collecting display information of a currently displayed web page in response to a web-page turning command for the displayed web page and storing the collected display information in the internal memory of the mobile terminal.

10. The method as set forth in claim 9, wherein the display information includes:
a uniform resource locator (URL) of the web page;
display-information collection time information; and
position information of a display area, to be displayed on a display unit.

11. The method as set forth in claim 10, wherein the display information further input-input information contained in the web page.

12. The method as set forth in claim 8, further comprising the step of:
(d) collecting display information of a currently displayed web page in response to a wireless Internet termination command, and storing the collected display information in the internal memory of the mobile terminal.

13. The method as set forth in claim 12, wherein the display information includes:
a uniform resource locator (URL) of the web page;
display-information collection time information; and
position information of a display area, to be displayed on a display unit.

14. The method as set forth in claim 13, wherein the display information further includes form-input information contained in the web page.

15. The method as set forth in claim 8, wherein step (b) further comprises the steps of:
(b-1) comparing a current time with a display information collection time of the detected display information; and
(b-2) displaying the loaded web page utilizing the display information only if the current time has not exceeded a preset valid time after the display information collection time.

16. The method as set forth in claim 8, further comprising the step of:
(e) periodically checking display-information collection time information previously stored in the internal memory of the mobile terminal and deleting corresponding display information when a current time has exceeded a preset valid time.
